(19) United States
(12) Patent Application Publication
(10) Pub. No.: US 2007/0039946 A1
(43) Pub. Date: Feb. 22, 2007

(54) Electrical load control apparatus and method

(76) Inventors: Atul Parkhi, Bangalore (IN); Srinivas Ramesh, Karnataka (IN)

Correspondence Address: CANTOR COLBURN, LLP, 55 GRIFFIN ROAD SOUTH, BLOOMFIELD, CT, 06002, US

(21) Appl. No.: 10/557,131

(22) PCT Filed: Oct. 30, 2003
(86) PCT No.: PCT/US03/34572

§ 371 Date: Nov. 16, 2005

(51) Int. Cl. H05B 1/02

(52) U.S. Cl. 219/501

(57) ABSTRACT

A control circuit for an electrical load connected to a power circuit includes a switch path having a switch and a series connected voltage generator, and a controller in signal communication with the switch. The switch path is in signal communication with the load and arranged to turn the load ON and OFF. The controller is responsive to a voltage at the power circuit under a switch OFF condition and responsive to a voltage at the voltage generator under a switch ON condition.

### CROSS-REFERENCE TO RELATED APPLICATIONS

This application claims the benefit of a priority under 35 U.S.C. 120 to PCT Patent Application No. PCT/US03/34572 filed Oct. 30, 2003, the entire contents of which are hereby incorporated by reference.

### BACKGROUND OF THE INVENTION

The present disclosure relates generally to a control circuit for an electrical load, and particularly to a control circuit responsive to power derived from the electrical load whether the load is OFF or ON.

Some heating, ventilation, and air conditioning (HVAC) systems may use electromechanical or thermomechanical thermostats to operate a low force internal switch, such as a mercury switch for example, that switches an HVAC controller. In such thermostats, energy provided by the temperature change in a controlled space is relied upon for generating a working force and/or displacement to operate the internal switch. While the thermostat is OFF, the thermostat may receive power from the HVAC controller, operating at 24 volt-AC for example, but when the thermostat is ON, the essentially zero voltage drop across the thermostat's internal switch shorts out the thermostat terminals. Without the desire for additional functionality during a thermostat ON condition, such electromechanical/thermomechanical thermostats may be appropriate for their purpose. However, at some installations, an electronically controlled thermostat may desirable because they can offer more functionality, such as programming and function display for example. However, such electronic thermostats require an auxiliary power source, such as a battery or a separate control voltage. With new installations, running additional control voltage wires may be possible, but adds to the labor and material cost of the installation. In older installations, running additional control voltage wires may be cost prohibitive, and while the use of a battery controlled electronic thermostat may provide an alternative solution to the control wire system, the use of a battery introduces a maintenance item that requires regular attention. Accordingly, there is a need in the art, of HVAC systems or any other system using an electronic controller, for an electrical control circuit that overcomes these drawbacks.

### SUMMARY OF THE INVENTION

A control circuit for an electrical load connected to a power circuit includes a switch path having a switch and a series connected voltage generator, and a controller in signal communication with the switch. The switch path is in signal communication with the load and arranged to turn the load ON and OFF. The controller is responsive to a voltage at the power circuit under a switch OFF condition and responsive to a voltage at the voltage generator under a switch ON condition.

A method of powering a control circuit and controlling an electrical load is disclosed, where the control circuit includes a switch path for turning the load ON and OFF and the electrical load is connected to a power circuit. In response to the load being in an OFF state and the switch path being open, a first voltage is received from the power circuit. In response to the load being in an ON state and the switch path being closed, a second voltage is received from across the switch path. The first voltage is an AC voltage, the second voltage is an equivalent DC voltage, and the second voltage has a value less than the AC-RMS value of the first voltage.

### BRIEF DESCRIPTION OF THE DRAWINGS

Referring to the exemplary drawings wherein like elements are numbered alike in the accompanying Figures:

FIG. 1 depicts an exemplary control circuit in accordance with embodiments of the invention;

FIGS. 2-4 depict exemplary switch paths for use in the exemplary control circuit of FIG. 1; and

FIG. 5 depicts a schematic of the exemplary control circuit of FIG. 1.

### DETAILED DESCRIPTION OF THE INVENTION

Embodiments of the invention provide a control circuit for an electrical load connected to a power circuit. The control circuit utilizes an arrangement that receives power from the power circuit feeding the load when the load is ON or OFF. Semiconductors are used to generate an appropriate control voltage when the load is ON. While the embodiments described herein depict a triac and a zener diode as an exemplary switch and voltage generator, respectively, other semiconductors or electromechanical devices may be equally suitable for performing some of the functions described herein. As used herein, the term triac (triode alternating current switch) refers to a three-terminal semiconductor device that controls and conducts current flow during both alternations of an AC (alternating current) cycle, where one of the three terminals is a gate that receives a control voltage for turning the triac into its conductive state. As used herein, the term zener diode refers to a type of diode that acts to provide a regulated voltage under a reverse bias condition, and to provide negligible voltage under a forward bias condition. The regulated voltage is referred to as the zener breakdown voltage. Operating specifications for triacs and zener diodes are available in technical publications.

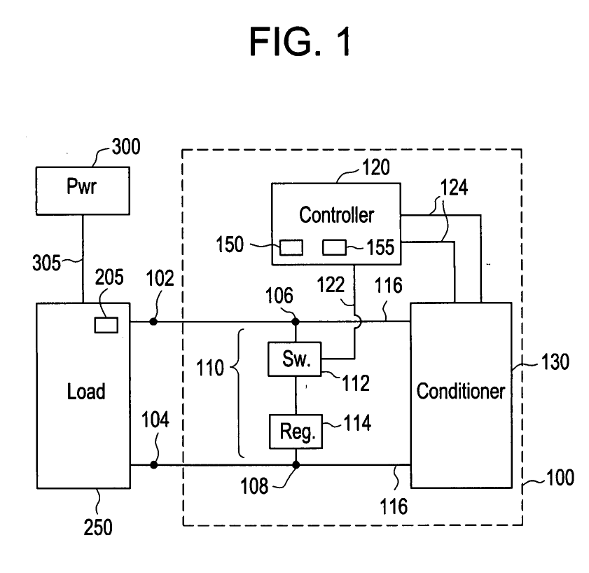

FIG. 1 is an exemplary embodiment of a control circuit 100 that controls the ON and OFF states of an electrical load 250. Control circuit 100 is connected to load 250 at terminals 102, 104. Load 250 is connected to and receives operational power from a power circuit 300. The power line 305 connecting load 250 to power circuit 300 is depicted in single-line fashion, which is representative of single-phase or three-phase power at a variety of voltages and is not intended to be limiting in any way. Control circuit 100 includes a switch path 110 that is in signal communication with load 250 and is arranged to turn load 250 ON and OFF. Switch path 110 includes a switch 112 and a series connected voltage generator 114. A controller 120 is arranged in signal communication with switch 112 via signal line 122. In response to switch 112 being OFF (open), load 250 is OFF, and controller 120 receives and is responsive to a voltage at power circuit 300 via power line 305 and voltage lines 116, 124. In an embodiment, power circuit 300 may operate at a high voltage, such as 120 or 240 VAC (volts AC) for example, while the voltage at terminals 102, 104 may operate at a low voltage, such as 24 VAC for example. Load 250 may include a step down transformer 205 to accomplish the appropriate voltage transformation, or transformer 205 may be separate from load 250. In response to switch 112 being ON (closed), load 250 is ON, and controller 120 receives and is responsive to a voltage at voltage generator 114 via voltage lines 116, 124. In the absence of voltage generator 114 in switch path 110, voltage lines 116 would be shorted via switch 112. However, in the presence of voltage generator 114, which will be discussed in more detail later, a voltage is present across voltage lines 116 when switch 112 is ON.

Control circuit 100 may also include a power conditioner 130, which is connected in parallel with switch path 110. Accordingly, in response to switch 112 being OFF, power conditioner 130 receives and is responsive to a voltage at power circuit 300, and in response to switch 112 being ON, power conditioner 130 receives and is responsive to a voltage at voltage generator 114.

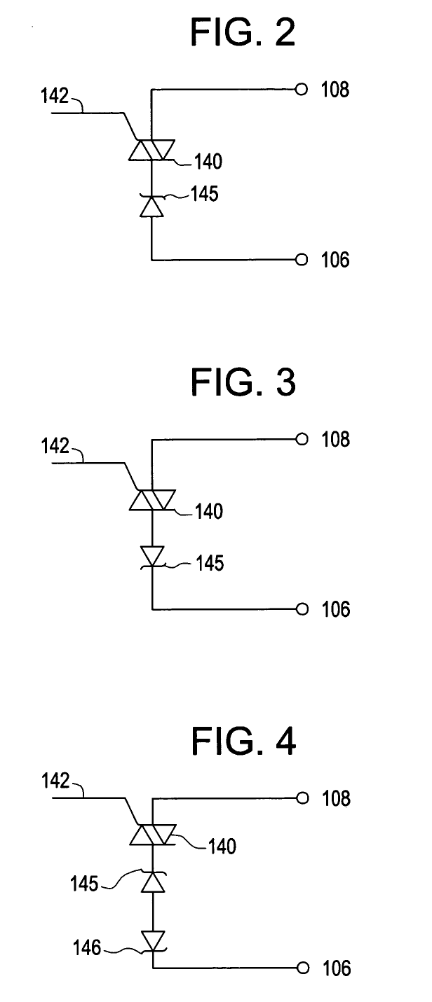

Referring to FIGS. 2-4, embodiments of the invention may employ semiconductors for switch 112 and voltage generator 114. Alternatively, an electromechanical switching device, such as a relay for example, may be employed for switch 112. An exemplary semiconductor for switch 112 is a triac 140, where the gate 142 of triac 140 is responsive to a signal from controller 120. An exemplary semiconductor for voltage generator 114 is a zener diode 145, which is depicted in a first polarity orientation as shown in FIG. 2 but may be employed in an opposite polarity orientation as shown in FIG. 3. Voltage generator 114 may include one or more zener diodes 145, 146, with one embodiment employing one zener diode 145, depicted in FIGS. 2 and 3, and another embodiment employing two zener diodes 145, 146, depicted in FIG. 4. In an embodiment employing two zener diodes, the two zener diodes are serially connected and arranged in opposite polarity with each other.

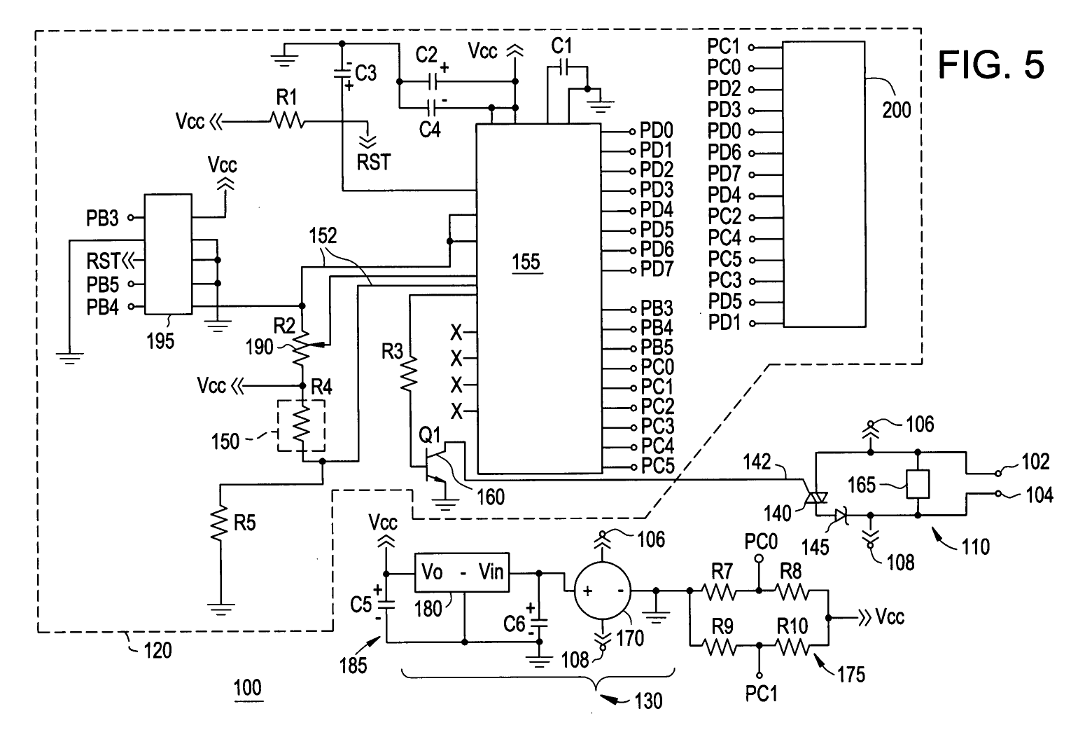

In an embodiment, controller 120 includes a sensor 150 for sensing an actionable condition, and a processing circuit 155 responsive to a signal from sensor 150. Sensor 150 may be a temperature sensor, a pressure sensor, a humidity sensor, or any other sensor suitable for sensing an actionable condition, such as an over/under temperature for example. In response to a signal from sensor 150 that is representative of an actionable condition, processing circuit 155 sends a control signal to triac 140, which changes triac 140 into its conductive state and turns switch 112 ON. A firing element 160, such as a transistor, best seen by referring to FIG. 5, may be employed between processing circuit 155 and triac 140 for firing triac 140, whereby firing element 160 is responsive to processing circuit 155 and triac 140 is responsive to firing element 160.

In an embodiment, load 250 is a heating unit, and switch 112 is arranged to turn ON the heating unit in response to the signal from temperature sensor 150 presenting a signal to processing circuit 155 that is indicative of a temperature at or below a threshold temperature, such as a programmed room temperature setting.

Exemplary embodiments of control circuit 100 may vary from each other, with one embodiment being illustrated by way of reference to FIG. 5. In FIG. 5, a more detailed illustration of an embodiment of control circuit 100 is depicted having switch path 110, power conditioner 130, and controller 120. Switch path 110 is connected to load 250 at terminals 102, 104. Triac 140 and a series connected single zener diode 145 are arranged between terminals 102, 104. In an embodiment, zener diode 145 has a zener breakdown voltage of about 4.7 VDC, with a power dissipation rating of about 5 Watts, which is sufficient to drive an embodiment of control circuit 100 having an operating voltage of about 3.3 VDC. However, it will be appreciated that zener diodes having other electrical characteristics may be employed in other designs implementing the teachings of the invention disclosed herein. It will also be appreciated that a back-to-back zener diode arrangement, such as that depicted in FIG. 4, may be employed in the embodiment of FIG. 5. Switch path 110 may include a transient voltage suppressor 165 across terminals 102, 104. Switch path 110 is connected in parallel with power conditioner 130 via terminals 106, 108.

Embodiments of power conditioner 130 include a bridge rectifier 170 for conditioning the input voltage at terminals 106, 108, and a low dropout regulator 180 and capacitor network 185 for further defining voltage Vcc. Power conditioner 130 provides controller 120 with conditioned voltage Vcc. The output of power conditioner 130 is a steady Voltage Vcc under both switch ON and switch OFF conditions. A resistor network 175 in signal communication with power conditioner 130 defines output voltages at pin connections PC0 and PC1.

Embodiments of controller 120 include processing circuit 155, such as a microprocessor for example, sensor 150, such as a thermistor for sensing room temperature for example, a potentiometer 190, which may be used for defining a desirable room temperature setting for example, a connector 195 for providing a means of programming microprocessor 155, a display 200, such as a liquid crystal display (LCD) for example, and a firing element 160, such as a transistor, for firing triac 140 at gate 142.

Embodiments of the invention may have components of control circuit 100 integral with or separate from each other. For example, switch path 110, power conditioner 130, and controller 120 may be arranged on a single platform, such as a printed circuit board for example, or multiple platforms, and sensor 150 may be co-located with controller 120 or remotely located therewith. Additionally, the components of control circuit 100 may be contained within a single housing, or within multiple housings in signal communication with each other. While sensor 150 is depicted having a wire runs 152 for signal communication with processing circuit 155, it is contemplated that alternative communication schemes may be employed, such as wireless or infrared for example.

In view of the foregoing structure, control circuit 100 is powered by the available voltage at terminals 102, 104 whether load 250 is ON or OFF, while also controlling the ON and OFF states of load 250. In response to load 250 being in an OFF state and switch path 110 being open, control circuit 100 receives a first voltage from power circuit 300. In an embodiment, the first voltage is about 24 VAC. In response to load being in an ON state and switch path 110 being closed, control circuit 100 receives a second voltage from across switch path 110 via terminals 106, 108. In an embodiment, the second voltage is defined by a voltage across switch 112 and the voltage across voltage generator 114. Where the voltage across switch 112 is considered negligible, the voltage at terminals 106, 108 is defined by the voltage across voltage generator 114. In an embodiment, the first voltage is an AC voltage and the second voltage is a clipped AC voltage with a value equivalent to about 4.7 VDC. Accordingly, the second voltage has an equivalent DC voltage that is less than the AC-RMS (root-mean-square) voltage of the first voltage. As used herein, the term equivalent DC voltage refers to a clipped AC voltage such as that seen across a zener diode, or any resultant voltage derived from an AC voltage that has the equivalent electrical effect of a DC voltage. The DC value of second voltage depends upon the rating of voltage generator 114 and is independent of the voltage at power circuit 300.

In response to receiving a signal from sensor 150 that is representative of an actionable condition, such as an under temperature condition for example, processing circuit 155 generates a control signal that is sent to firing element 160. In response to the control signal, firing element 160 energizes gate 142 of triac 140 thereby activating triac 140 to its conductive state and effectively turning switch 112 and load 250 ON. In response to switch 112 being closed, a voltage is impressed across terminals 106, 108 that exceeds the zener breakdown voltage of zener diode 145, thereby resulting in current flow through switch path 110 and the generation of the second voltage equivalent of about 4.7 VDC, or the zener breakdown voltage, across terminals 106, 108. Accordingly, in response to switch 112 being closed, the input voltage at terminals 106, 108 changes from the first voltage of about 24 VAC to the second voltage equivalent of about 4.7 VDC. In an embodiment where a single zener diode 145 is employed, the second voltage (switch 112 closed) of equivalent about 4.7 VDC at terminals 106, 108 is only present where power circuit 300 has a first voltage polarity that reverse biases zener diode 145, otherwise the second voltage has a negligible value of the forward bias voltage drop across zener diode 145, which is about 0.3 to about 0.7 VDC. In an embodiment where two back-to-back zener diodes 145, 146 are employed, the second voltage equivalent of about 4.7 VDC at terminals 106, 108 is also present where power circuit 300 has a second voltage polarity, opposite to the first voltage polarity, that reverse biases the second zener diode 146. Accordingly, a two zener diode arrangement provides a second voltage (switch 112 closed) at terminals 106, 108 during both alternations of the AC cycle of power circuit 300, while a single zener diode arrangement provides a second voltage at terminals 106, 108 only during one alternation of the AC cycle of power circuit 300.

Upon receiving either a first voltage (switch 112 open) or a second voltage (switch 112 closed), power conditioner 130 conditions the input voltage received at terminals 106, 108 to produce a conditioned output voltage Vcc, which is received at controller 120 and used for powering processing circuit 155 and other components of control circuit 100. Accordingly, the operational characteristics of control circuit 100 are designed to function at both the first voltage level, 24 VAC for example, and the second voltage level, 4.7 VDC for example.

While embodiments have been described having a particular first voltage and second voltage at terminals 106, 108, which are defined by power circuit 300, transformer 205, and the zener breakdown voltages of zener diodes 145, 146, it will be appreciated that other designs may employ other system components having other operational voltages.

As disclosed, some embodiments of the invention may include some of the following advantages: operation of load control circuit from load power source with load ON or OFF; retrofit of control circuit without requiring a change in the existing installation; absence of external batteries thereby reducing maintenance cost and time; cost effective solution for providing load control; and, a semiconductor or electromechanical switch that stays ON in response to an ON signal as opposed to being switched ON and OFF at each current zero, thereby reducing switching noise.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A control circuit for an electrical load connected to a power circuit, the control circuit comprising:
a switch path in signal communication with the load and arranged to turn the load ON and OFF, the switch path having a switch and a series connected voltage generator; and
a controller in signal communication with the switch;
wherein the controller is responsive to a voltage at the power circuit under a switch OFF condition and responsive to a voltage at the voltage generator under a switch ON condition.

2. The control circuit of claim 1, further comprising:
a power conditioner connected in parallel with the switch path;
wherein the power conditioner is responsive to the voltage at the power circuit under a switch OFF condition and responsive to the voltage at the voltage generator under a switch ON condition; and
wherein the controller is responsive to a voltage at the power conditioner.

3. The control circuit of claim 1, wherein:
the switch comprises a semiconductor or an electromechanical switching element and the voltage generator comprises a semiconductor.

4. The control circuit of claim 3, wherein:
the switch comprises a triac; and
the voltage generator comprises a first zener diode.

5. The control circuit of claim 4, wherein:
the voltage generator further comprises a second zener diode serially connected and arranged in opposite polarity with the first zener diode.

6. The control circuit of claim 4, wherein:
the triac is responsive to the controller.

7. The control circuit of claim 6, wherein:
the controller includes a sensor and a processing circuit, the sensor adapted to provide a signal to the processing circuit that is representative of an actionable condition; and
the triac is responsive to the signal from the sensor.

8. The control circuit of claim 7, wherein:
the sensor is a temperature sensor; and
the actionable condition is a measurable temperature.

9. The control circuit of claim 7, further comprising:
a firing circuit in signal communication between the processing circuit and the triac;
wherein the firing circuit is responsive to the processing circuit and the triac is responsive to the firing circuit.

10. The control circuit of claim 8, wherein:
the load includes a heating unit; and
the switch is arranged to turn ON the heating unit in response to the signal from the temperature sensor being indicative of a temperature at or below a threshold.

11. A method of powering a control circuit and controlling an electrical load, the control circuit having a switch path for turning the load ON and OFF, the electrical load being connected to a power circuit, the method comprising:
in response to the load being in an OFF state and the switch path being open, receiving a first voltage from the power circuit;
in response to the load being in an ON state and the switch path being closed, receiving a second voltage from across the switch path;
wherein the first voltage is an AC voltage, the second voltage is an equivalent DC voltage, and the second voltage has a value less than the AC-RMS value of the first voltage.

12. The method of claim 11, wherein the switch path includes a switch and a series connected voltage generator, the method further comprising:
receiving a sensor signal, the sensor signal representative of an actionable condition;
in response to the sensor signal, generating a control signal;
in response to the control signal, turning the switch and the load ON; and
in response to the switch being closed, generating the second voltage and changing an input voltage at the control circuit from the first voltage to the second voltage.

13. The method of claim 12, wherein the switch includes a triac and the voltage generator includes a first zener diode, the method further comprising:
activating the triac to a conductive state; and
generating a first zener breakdown voltage across the first zener diode in response to the power circuit having a first voltage polarity;
wherein the second voltage is equal to or less than the first zener breakdown voltage.

14. The method of claim 13, wherein the voltage generator includes a second zener diode connected in series but in opposite polarity with the first zener diode, the method further comprising:
generating a second zener breakdown voltage across the second zener diode in response to the power circuit having a second voltage polarity;
wherein the second voltage is equal to or less than the first zener breakdown voltage in response to the power circuit having a first voltage polarity, and equal to or less than the second zener breakdown voltage in response to the power circuit having a second voltage polarity.

15. The method of claim 13, further comprising:
conditioning the first and the second voltage to produce a conditioned voltage; and
receiving the conditioned voltage at a processing circuit.

16. The method of claim 15, further comprising:
firing the triac via a signal from the processing circuit.
